(19) United States
(12) Patent Application Publication
(10) Pub. No.: US 2015/0039113 A1
(43) Pub. Date: Feb. 5, 2015

(54) Method and apparatus for 3D printing along natural direction

(71) Applicant: Yasusi Kanada, Tokyo (JP)

(72) Inventor: Yasusi Kanada, Tokyo (JP)

(21) Appl. No.: 14/449,341

(22) Filed: Aug. 1, 2014

(30) Foreign Application Priority Data
Aug. 4, 2013 (JP) 2013-161928

(51) Int. Cl. B29C 67/00; G06F 17/50

(52) U.S. Cl. CPC B29C 67/0088; G06F 17/50
USPC 700/98

(57) ABSTRACT

The purpose of this invention is to enable forming 3D objects by a 3D printer by establishing a method for describing 3D models with directions, a method for modeling such models, a method for slicing 3D models with directions, and a method for printing 3D objects with directions when each portion of a 3D object has its natural direction in a layered 3D-printing process.

To solve the problem above, the following means are to be used. First, a method for modeling 3D objects by using an extended solid-model, which contains the natural direction of each part represented as a vector at each location in the model. Second, when slicing an object, perform the following processes in this order: object-division processing, extrusion-amount-control processing, division-granularity-control processing, and printing-enabling processing. Third, by using needle-style-nozzle printing-method or rotatable-nozzle printing-method, objects are printed by using a 3D printer.

### BACKGROUND OF THE INVENTION

A basic technology of 3D printers of so-called fused-deposition-modeling type, which use ABS resin or PLA resin filament, are described in the U.S. Pat. No. 5,136,515 by Richard Helinski. In addition, there are other types of 3D printers that uses materials which are gel state in room temperature but becomes solid by heat or light. By using such technologies, object models to be printed are sliced to thin layers, and each layer is formed by arraying filament in horizontal directions, and the layers are stacked. Because this type of process is used, the directions of filaments can usually be observed on 3D printed objects. However, although the shape of filament is mostly as is when print is relatively sparse (i.e., the pitch is large), filaments may be fused each other and only a limited number of lines along the directions may be observed. Because the printing direction is horizontal, the observable directions are restricted to horizontal.

### BRIEF SUMMARY OF THE INVENTION

### Problems to be Solved by this Invention

Each portion of a 3D object to be expressed by printing may have natural direction. For example, shapes of parts of animals and plants, such as hairs, natural fabric or leaf veins, may have direction in each portion, and shapes of artificial objects, such as artificial fabric, or calligraphy work, also have direction. In such cases, where models to be printed have natural directions (i.e., directions that the objects originally express), the natural directions can be expressed on 3D-printed objects if the directions of filament coincide the natural directions. However, when the natural direction is not horizontal, if the object is printed in a conventional 3D-printing method, the models are sliced in different directions from the natural directions, and expression of natural directions is prevented.

To solve this problem, the printing direction must coincide with the natural direction. However, three challenges must be successfully achieved for this purpose. The first challenge is to establish a method of describing 3D object models with specifications of natural directions and to establish a method of modeling 3D objects. In conventional 3D printing, 3D models are defined as solid models and the models are sliced for 3D printing. However, in solid models, directions cannot be specified. A modeling method that can express natural directions is thus required.

The second challenge is to establish a method for slicing (or partitioning) 3D object models with specifications of natural directions, which can partition the models, even when the natural directions depend on the location in the object. If the natural direction is the same for all the locations in the object, the direction can be expressed by arraying filaments in parallel, that is, by shifting the print head and printing repeatedly. However, if the natural direction is expressed as vectors whose directions depend on locations, as shown in FIG. 1, there are two possible cases. The first case is that the vectors close to each other have diffusing directions as shown in FIG. 1(a). The second case is that the vectors have converging directions as shown in FIG. 1(b). In addition, the vectors may have diffusing directions in some direction but may have converging directions in some direction as shown in FIG. 1(c). In all these cases, the model must be printed without a hollow and without excess filament.

The third challenge is that the restrictions of conventional 3D printers on print directions must be eliminated. The heads of conventional 3D printers can move vertically. However, because the nozzles have certain widths. If printing with steep direction, i.e., moving up or down, the nozzle may collide with previously printed layers, the nozzle must be apart from the layers, and it is not possible to print exactly and thickly as shown in FIG. 1(d). Therefore, the horizontal angle is not allowed to be steep. This constraint must be eliminated.

### Means to Solve the Problems

The first challenge, i.e., to establish a modeling with natural directions, can be achieved by expressing the natural direction at each of multiple points inside the object by a vector, using an extended solid model that consists of a conventional solid model and the vectors, and using a 3D paint tool to generate an extended solid model. The natural direction in the extended solid model is similar to a field (such as a magnetic field). This field is called a “printing field”. A vector is specified in each point in the model similar to a magnetic line (direction) and magnetic force (strength) is specified in each point in a magnetic field.

Two methods can be used for generating the extended solid models. The first method is to prepare CAD parts with a printing field for 3D CAD tools. By using a 3D CAD tools, the user assembles prepared parts and modifies them to build up a model. If a printing field is specified in each prepared part, natural directions can be expressed at each location in the model. The second method is to describe a 3D model by using a 3D paint tool with a 3D pointing device that inputs coordinates in the 3D space at each time step. By adding the motion direction of the pointing device, a 3D model with a printing field can be generated and can be converted to an extended solid model.

The second challenge, i.e., to establish technologies to slice a model with natural directions, can be achieved by combining the following four processes when slicing the model. The first process called the “object partitioning process” is a process that partitions the model into many string-shaped portions (or filaments). In this process, the layer thickness and the width of the filament are decided by the diameter of the hole of the nozzle tip when starting slicing, and the cutting surface is decided by connecting direction vectors. However, the thickness of the string-shaped portions depends on the location.

The second process called the “extrusion amount adjustment process” is a process that computes and adjusts the amount of filament extrusion from the nozzle. The amount is adjusted in proportion to the cross section of each string-shaped motion. That means, this process adjusts the amount of extrusion when the change of the filament cross-section becomes larger than the predefined amount. Otherwise, the process adjusts the amount when the head moves a certain amount.

The third process called the “partition granularity adjustment process” is a process that changes the number of slices (or vertically-arrayed filaments) or the number of horizontally-arrayed filaments. When the a filament becomes thicker than the predefined thickness, the number of slices is updated. When it becomes wider than the predefined width, the number of horizontally-arrayed filaments is updated.

The forth process called the “printability enhancement process” is a process that judges whether the model is printable without partitioning and, if it is not printable, the model is modified so that it becomes printable. The printability is determined by using information of the shape and possible directions of rotation (i.e., whether the machine is 3-axis, 5-axis, etc.). To make the model printable, it is partitioned and a printing order is selected (changed) so that the each partitioned portions is printable.

By these four processes, a model with a printing field can be sliced and an NC program can be generated.

The third challenge, i.e., to enable printing with steep motion of the nozzle, is achieved by applying one or both of the following two methods. The first method called the “needle-shaped-nozzle printing method” is a method for improving the shape of print heads, especially that of nozzles so that it enables printing by steep motion. By using a needle-shaped nozzle, steep-direction printing is enabled. However, because a thin nozzle makes filament temperature lower, it is necessary to cover the nozzle by insulator or to increase the temperature of filament sufficiently high. By installing a temperature sensor close to the nozzle tip and by controlling the temperature so that the viscosity of filament becomes sufficiently low (i.e., the filament becomes sufficiently soft), steep-direction printing is enabled.

The second method called the “nozzle-rotating printing method” is a method that rotate the print head to adjust the angle of the nozzle vertical or closely vertical to the printing direction. Conventional 3D printers are 3-axis machining tools, and they cannot rotate the head. However, by using a 5-axis head similar to machining tools such as milling machines, the print head can be rotated on a horizontal axis (i.e., x-axis and/or y-axis), and steep-angle printing is enabled.

### The Effect of this Invention

This invention enables a 3D printer that can print a 3D object along natural directions and express the directions by the printed 3D object.

### BRIEF DESCRIPTION OF DRAWINGS

FIG. 1 explains the problem to solve by this invention: it shows the diffusion and conversion of vectors close to each other.

FIG. 2 shows the flow of 3D printing and modeling for it in the embodiment of this invention.

FIG. 3 shows an example of a 3D model which a printing field that expresses the natural directions in each point in the object in the embodiment of this invention.

FIG. 4 shows parts used for solid modeling in the embodiment of this invention.

FIG. 5 shows the method of generating a 3D model with a printing filed by “magnetizing” a conventional 3D model in the embodiment of this invention.

FIG. 6 shows the method of generating a 3D model with a printing field by using a 3D pointing device in the embodiment of this invention.

FIG. 7 shows the method for the extended slice process 203 which generates an NC program for printing an object with natural directions by slicing a 3D model with a printing field in the embodiment of this invention.

FIG. 8 shows the structure of a print head for printing with a steep-angle motion in the embodiment of this invention.

FIG. 9 shows the mechanism for rotating a print head for printing with steep-angle motion in the embodiment of this invention.

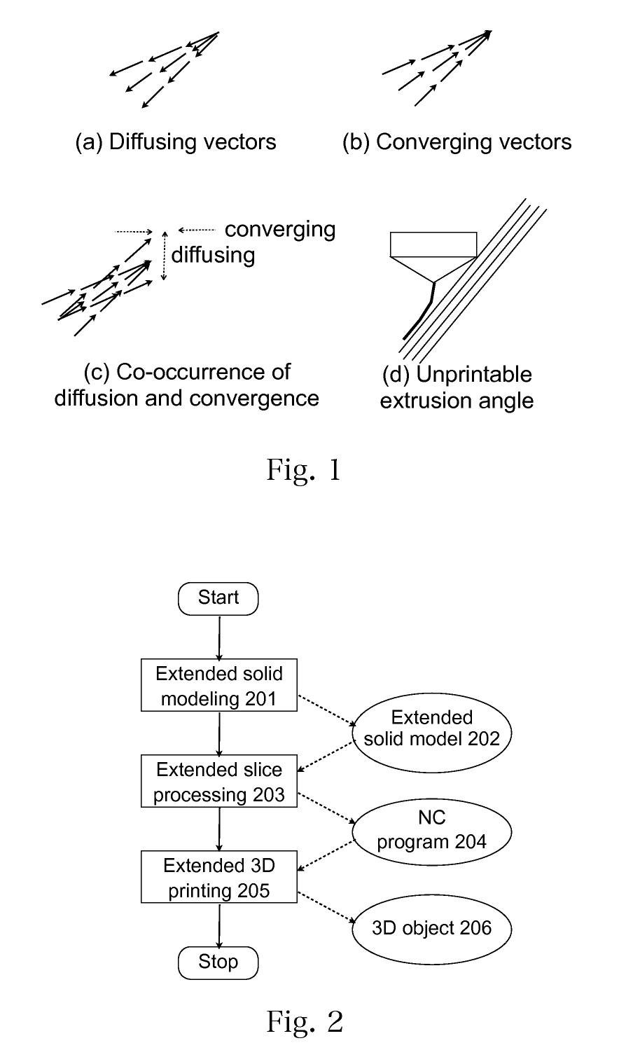

### DETAILED DESCRIPTION OF THE INVENTION (EMBODIMENT)

FIG. 2 shows the flow of modeling a 3D object with natural directions and printing it. First, by the extended solid modeling process 201, an extended solid model 202 is generated. Next, by the extended slice process 203, the extended solid model 202 is inputted and sliced, and an NC program 204, which is described by G-Code, is outputted. Finally, by the extended 3D printing process 205, the NC program 204 is inputted and a 3D object 206 is generated.

For the relationship between the extended solid modeling process 201 and the extended slice process 203, either the batch processing method that input the extended solid model 202 after it is outputted or the pipeline processing method (the real-time processing method) that input it while it is computed can be selected. In addition, either the batch processing or pipeline processing can be selected for the extended solid model 202. Moreover, instead of using the extended solid model 202, another type of directed 3D model, such as a directed wire-frame model can be used.

The three processes, i.e., the extended solid modeling process 201, the extended slice process 203, and the extended 3D printing process 205, are explained in this order below.

### [Modeling]

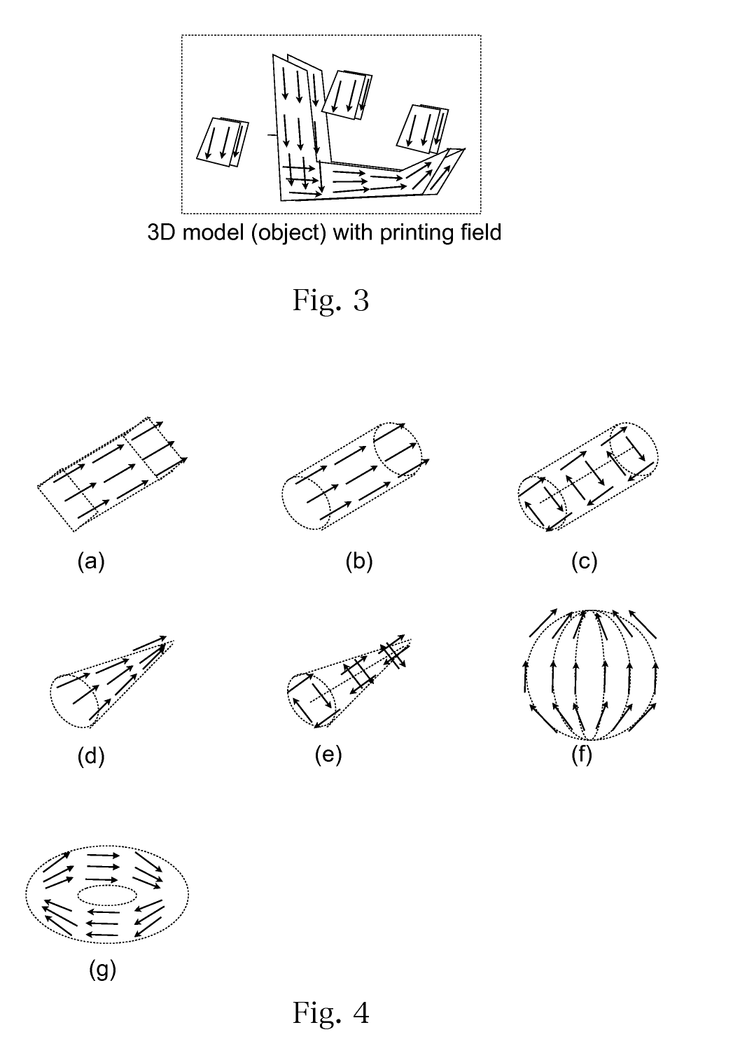

First, the extended 3D model 202 and the first process, i.e., the extended solid modeling process 201, are explained. The extended solid model is explained as follows. Conventional solid models cannot express natural directions that the object has. To express natural directions, a direction in each point of the object is expressed as a vector, and the vectors are added to the solid model. FIG. 3 shows an object with a complex shape such as a designed character with a 3D shape, which is expressed by a directed extended solid model. In FIG. 3, a directed vector is defined for each point in an object; however, the direction specified for each point may be undirected and the length is not necessarily specified, so the vector may be undirected and have a constant length.

Next, the method of modeling objects, i.e., the extended solid modeling process 201, is described. To generate an extended solid model 202 as described above, one of the three methods can be used: the first method called the “method of assembling parts with a printing field”, which is based on 3D CAD method and prepares parts with printing fields, the second method called the “solid model magnetization method”, which “magnetize” conventional 3D models or parts without printing fields to add a printing fields, and the third method called the “directed 3D painting method”, which uses a 3D paint tool to design an extended solid model 202.

The first method, i.e., the method of assembling parts with a printing field, can be explained as follows. In a 3D CAD method, parts to be used are selected from prepared parts, assembled, and processed to generate a model. To assemble parts, union, intersection, difference, and other set operations are used. If a printing field is specified in each part, a whole field can be specified for the model. However, when a union or intersection operation is applied, two methods can be used. The first method is to add vectors of both parts. The second method is to select vectors of one part. When a difference operation, A−B, is applied, the vectors of A are taken for the results. When expressing natural direction, there is no need to specify directed vectors or vectors with a length. However, when applying such quantitative operations in the first method, the resulting vectors depend on the direction and the length of the original vectors.

Basic parts are described in FIG. 4. FIG. 4(a) shows a cuboid (or a cube) that has a uniform printing field. The length of the printing-field vector can be specified as a parameter as well as the size of the cuboid. The vector may be specified as either directed or undirected. The length of the vectors may have 1-dimensional or 2-dimensional gradient instead of specifying a uniform vector. The parameter(s) for specifying the gradient can be specified in a similar method as a length specification.

FIG. 4(b) shows a cylinder with a uniform printing field. For this cylinder, the length or the gradient of the vectors can be specified as parameters in the same way as in the cuboid. FIG. 4(c) shows a cylinder with directions of concentric circles. The vector length can be specified for this cylinder too. The gradient of the vectors from the center to the radial direction can also be specified in the same way.

FIG. 4(d) shows a cone with a printing field toward the tip of the cone. The length and gradient of the vectors of the printing field toward the axis can be specified as parameters. FIG. 4(e) shows a cone with directions of concentric circles. The length and gradient of the vectors toward the tip can also be specified as parameters.

FIG. 4(f) shows a sphere with a printing field from the south pole to the north pole, which is similar to the magnetic field of the globe. A vector length can also be specified for this sphere as a parameter too. A gradient from the center of the sphere to the radial direction can also be specified as a parameter. A sphere with directions of concentric circles can also be specified.

FIG. 4(g) shows a torus with directions of the axis. A torus with directions of concentric circles can also be specified.

By assembling these parts, objects with a printing field that is specified for each part with different policies can be generated.

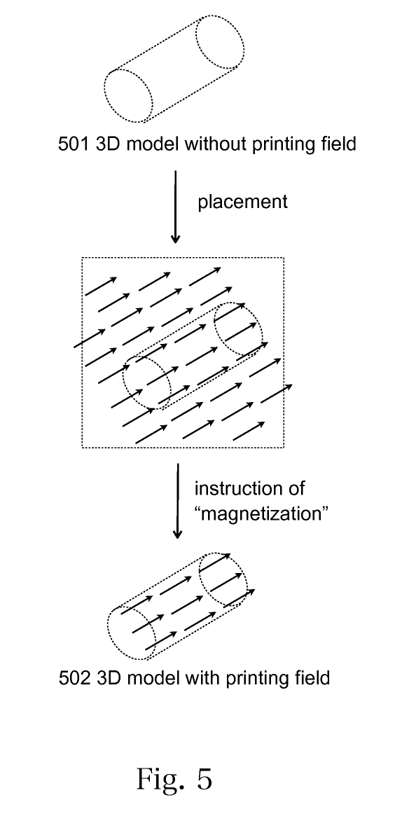

Next, FIG. 5 explains the second method, i.e., the solid model magnetization method. Objects designed by conventional modeling methods or parts used for conventional modeling, which do not have printing directions, can be “magnetized” by placing it in a space with a printing field, in which vectors are defined in whole space. By an instruction of the user, the printing field is copied to the object or part (that is, the object or part is “magnetized”). There are at least two types of printing field, i.e., uniformly directed printing-field and concentric printing-field.

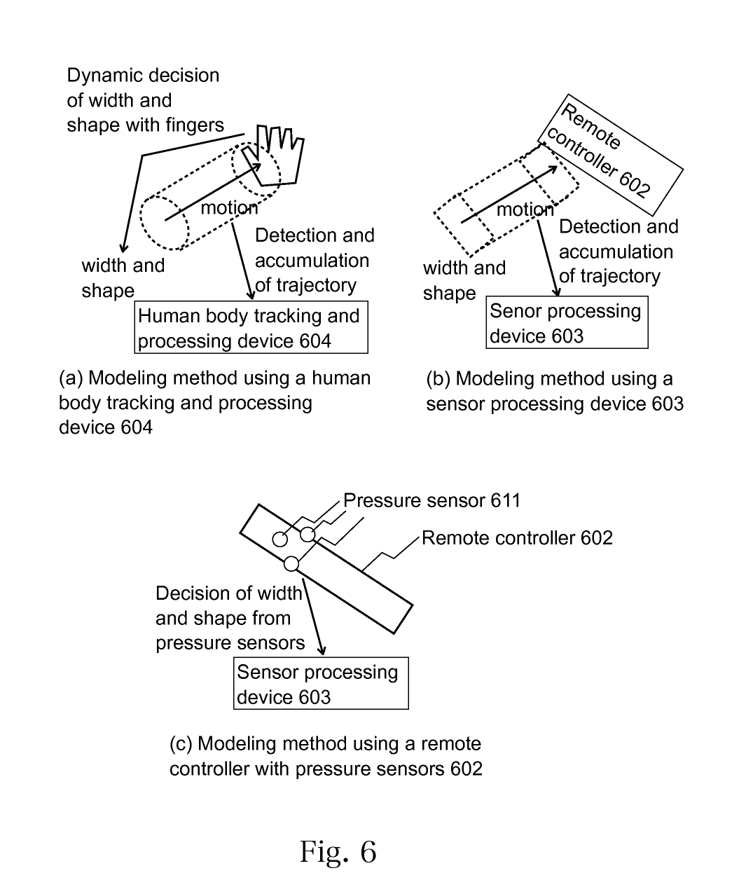

Finally, FIG. 6 explains the third method, i.e., the directed 3D painting method. Two-dimensional paint tools are widely used for personal computers. By using a similar methods, a three-dimensional paint tool, which can be used for describing 3D models with a printing field, can be implemented. The following two methods can be used fin a 3D painting tool. The first method is a method that use a human hand as a 3D pointing device and that use a human tracking and processing device 604, such as Microsoft Kinect, as the processing device of the tool (see FIG. 6(a)). The second method is a method that use a remote controller 602, mobile terminal, or smartphone that contains a sensor 601, such as an acceleration sensor that can detect the location or motion (see FIG. 6(b)). This method also use a sensing data processor 603 such as Nintendo Wii as the processing device. By using one of these methods, 3D location or motion can be detected, and the trajectory and the motion direction and velocity can be tracked and stored, and these enable implementation of a 3D painting tool that can describe 3D models with a printing field.

As described in FIG. 6, in the same way as drawing a 2D shape by using a 2D painting tool that can specify a 1D or 2D spread by the pointer of the 2D pointing device, a 3D shape, i.e., a 3D model, can be drawn by using a 3D painting tool that can specify a 2D or 3D spread by the pointer of the 3D pointing device. By specifying a spread for the pointer, a single motion of the pointer can specify a trajectory, which is a rarely string-shaped solid, with a wider spread that can cover wider range, can fill the 3D space with a relatively small number of motions, and can input a large 3D model. The width and shape of the pointer can be specified by the human tracking and processing device 604 or the sensing data processor 603.

In particular, to change the width or shape of the pointer dynamically, one of the following two methods can be used. The first method is a method that uses the human tracking and processing device 604. By using the human tracking and processing device 604, trajectories of multiple points specified by multiple fingers or portions of a human body can be detected in parallel, and the distance of the multiple points or the shape formed by them can specify the width and shape of the trajectory and can change them dynamically (FIG. 6(a)). To determine a 2D shape by using the multiple points, the easiest method is to connect them by lines, and another method is to connect them by a spline curve. In addition, to determine a 3D model by generating a trajectory by moving a 2D shape, publicly available methods used in many 3D CAD tools can be used.

The second method is a method that uses the remote controller 602 that contains the sensor 601. As described in FIG. 6(c), one to three pressure sensors 611 can be added to the remote controller 602, and, when using it, one to three fingers can be put on the pressure sensors 611. By changing the width or shape of the trajectory according to the pressure measured by the pressure sensors 611, they can be changed dynamically. If the first pressure between the first and third fingers is strong, the width along the x-axis can be made narrower. If the second pressure by the second finger is strong, the width along the y-axis can be made narrower. Here, it is assumed that the z-axis is the direction of the motion, and that the x-axis and the y-axis are the orthogonal to the z-axis.

By adjusting the first and the second pressures by the above method, the model can be formed by a thicker and fewer trajectories in some cases, and it can be formed by a thinner and more trajectories in other cases. These methods can be used when it is not necessary to detect the natural direction, i.e., in the case of generating normal 3D models.

The shape drawn by a 2D painting tool can be completely verified by a 2D display, and whether it is correctly drawn can be fed back to the user while drawing. However, because a 3D model cannot be completely expressed on a 2D display, it is not easy to see whether it is correctly drawn. By using a 3D CAD tool, the 3D shape of a 3D model can be more precisely grasped by rotating the 3D model. However, when using a 3D pointing device, rotating the 3D model to a direction different from the input direction may confuse the user. Therefore, instead of using a 2D display, it is better to use a 3D display (such as a head mounted display), which can display the trajectory in the space pointed by the 3D pointing device by using augmented reality (AR). That means, each time a trajectory is generated, it is displayed by AR.

### [Slices]

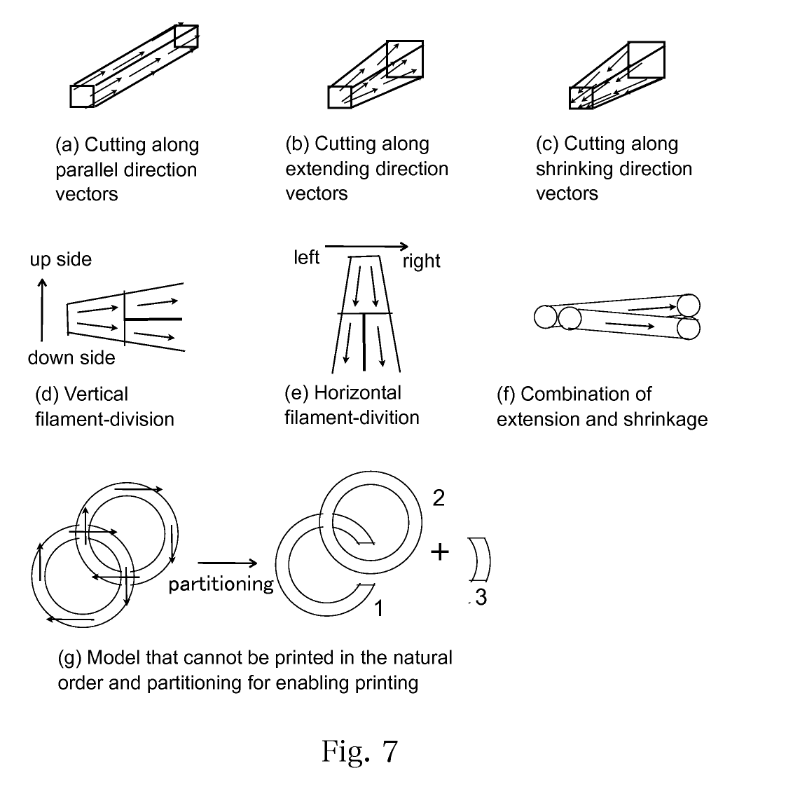

Second, FIG. 7 explains the extended slicing process 203. The first process that consists two steps, i.e., the “object division process”, is explained. The first step is a step that specifies a certain point in the object (3D model) with a printing field and that decides the initial state of the layer thickness and the filament width from the diameter of the hole at the nozzle tip. If the hole diameter is 0.5 mm, it will be better to be a little bit smaller, e.g., 0.4 mm. That means, the thickness t and the width w of filament, i.e., the size of the string-shaped portion, are determined so that the filament extruded by the nozzle tip, which is a cylinder with approximately 0.4 mm diameter, fills the cuboid-shaped (rectangular) space without a gap when the shape of the filament is deformed to the cuboid whose size is t by w. The size of the nozzle hole is predefined, so the thickness and the width can be determined before performing the extended slicing process 203.

In the second step, the object is cut at the above thickness and the width. That means, it is cut along the direction vector at the cutting point as shown in FIG. 7(a). If the direction other vector of the cutting point is varied as shown in FIGS. 7(b) and 7(c), the cutting point is varied to follow the vector.

As shown in FIG. 7(b) and (c), the cross section of the filament, i.e., string-shaped portion, is varied from place to place. While the variance is small, the amount of extrusion is adjusted by the second process, i.e., “extrusion amount adjustment process”. That means, the amount of filament is managed to be without excess nor deficiency, i.e., the specified thickness and width are exactly filled, by using one of the following three methods;

1) the motion velocity of the nozzle is variance while the extrusion velocity (i.e., the velocity of filament) from the nozzle is kept constant,

2) the extrusion velocity from the nozzle is variance while the motion velocity of the nozzle is kept constant, or

3) both the motion velocity of the nozzle and the extrusion velocity from the nozzle are variance.

When controlling the extrusion by an NC program such as G-Code, it is not possible to change the extrusion velocity continuously. Therefore, when the cross section of the filament becomes over or under a certain value, a command is generated to change the extrusion velocity. For example, when the cross section becomes 1.1 times the initial value, the extrusion velocity is set to 1.1 times the initial value, and when the cross section becomes 0.92 times the initial value, the extrusion velocity is set to 0.92 times the initial value. When G-Code is used, if a single G-Code command should fill the range from (a0, b0, c0) (i.e., x=a0, y=b0, z=c0) to (a2, b2, c2) (i.e., x=a2, y=b2, z=c2), and if the initial position of the filament, which is specified by the absolute position, e=d0, if the cross section at the initial position, if the cross section is at the initial position, if the filament required for unit length (quantity) is e, and if the cross section becomes 1.1 times the initial value at the location (a1, b1, c1) (i.e., x=a1, y=b1, z=c1), the commands to be generated is as follows.

G1 Xa0 Yb0 Zc0 E d0 (1)

G1 Xa1 Yb1 Zc1 E d1 (2)

G1 Xa2 Yb2 Zc2 E d2 (3)

Here, d1 and d2 are values that satisfy the following expressions (where “̂” means “power”).

d1=d0+e sqrt((a1−a0)̂2+(b1−b0)̂2+(b1−b0)̂2)

d2=d1+1.1 e sqrt((a2−a1)̂2+(b2−b1)̂2+(b2−b1)̂2)

If the head position is (a0, b0, c0) (i.e., x=a0, y=b0, z=c0) when starting the command, there is no need to generate command (1).

Otherwise, instead of detecting increase or decrease of the cross section, the filament extrusion velocity can be controlled by generating an NC command for each certain distance.

However, if the thickness or the width changes very fast so that it becomes much larger or smaller than the nozzle hole diameter, it is not possible to form an object. The third process, i.e., “division granularity adjustment process”, is required in such cases. By this third process, one of the following process is performed;

1) if the thickness is over a certain value, the number of slices (vertical number of filaments) are updated (increased), or

2) if the width is over a certain value, the number of horizontally arrayed filaments is updated (increased).

In both FIG. 7(d) and (e), a thick line shows the line (actually a plane because thickness is not zero) that partitions the object.

With both the thickness and width are increased, both the number of vertical and horizontal filaments are increased. With both the thickness and width are decreased, both the number of vertical and horizontal filaments are decreased. With one of the thickness or the width is increased but the other is decreased, the number of filaments for the former is increased and the number of filaments for the latter is decreased. However, in this case, the following treatment is possible. As shown in FIG. 7(f), that is, it decreases for the horizontal direction but it increased for the vertical direction, the neighbor filament (or, string-shaped solid) can be twisted so that horizontally-arrayed filaments at one end are vertically-arrayed at the other end.

In addition, there are shapes that cannot be printed by applying all the above methods; the left figure of FIG. 7(g) shows a seamless chain that consists of two rings, which is an unprintable shape. That means, if trying to print a ring after printing the other ring along the natural direction, i.e., the circumferential direction, the first ring cannot be printed because the second ring disturbs the printing process. This problem cannot be solved by using any shape of nozzle.

Therefore, the forth process, i.e., “the printability enhancement process”, which partitions an unprintable object into multiple objects that can be printed, is introduced. As shown in the right figure of FIG. 7(g), one of the rings is partitioned at a point close to one of the two locations where the two rings are overlapped.

The numbers described in the figure indicates the order of printing. That means, one of the partitioned portions of the ring is printed first, whole of the second ring is printed second, and the other portion of the first ring is printed third and connected to the first portion. Although not all unprintable objects can be made printable by using this method, this method can enhance printability of the printing method described in this patent.

### [Printing]

Third, the extended 3D object printing method is explained. To make printing along a steep angle possible, one of the following two methods can be applied to the printing process.

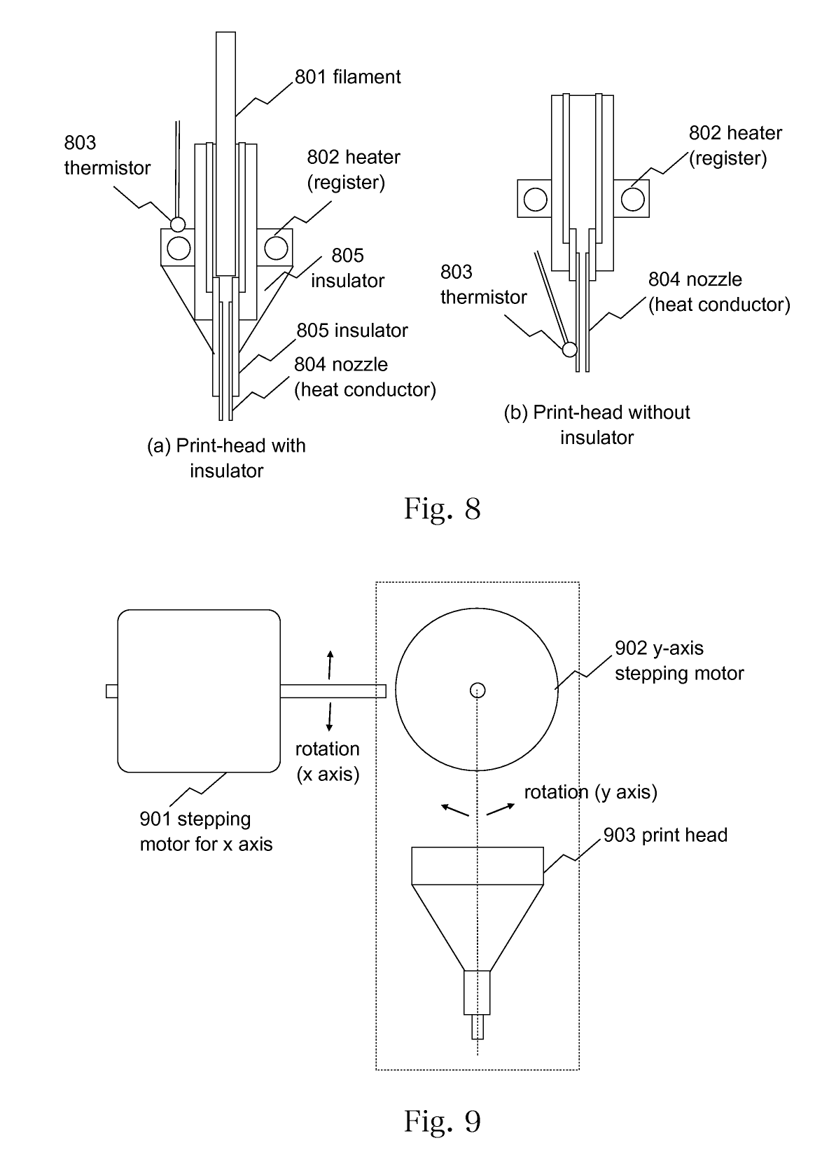

FIG. 8 shows the first method. The print head, especially the shape of the nozzle at the tip of the head, is improved in this method. That means, the nozzle tip is formed to a shape similar to a needle as shown in FIG. 8(b). This makes steep-direction printing possible.

However, if a nozzle as thin as a needle is used, the filament 801 is cooled while running through the nozzle; so the temperature of the nozzle must be controlled to keep the low viscosity of the filament at the nozzle tip. To enable this control, one of the two methods, A and B, is used.

The method A is a method for covering the nozzle is covered by insulator except the tip. The filament 801 is cooled when running through the nozzle, but sufficient amount of insulator avoids temperature decrease. The initial temperature of filament, which means the temperature when the filament is close to the heater, should be sufficiently high by heating it. The nozzle must be made by heat conductor such as metal, but not by insulator, because filament 801 must be heated even when filament 801 is not extruded so that solidification of filament is avoided. When using the method A, a thermistor, which is required, for temperature control of the nozzle can be placed at a close position to the heater 802. Because of existence of insulator 805, the temperature difference between the thermistor and the nozzle tip can be reduced.

The method B is a method that places a thermistor 803 at a close position to the nozzle 804. It is assumed that the nozzle 804 is made by heat conductor but not using insulator, as shown in FIG. 8(b). Because no insulator is used, this method cannot avoid temperature decrease of the tip of the nozzle 804 compared with the temperature of the filament 801. However, by controlling the temperature of the tip of the nozzle 804, the temperature can be kept within a proper range.

By using one of the above methods, to print with steep angle is enabled.

FIG. 9 explains the second problem. This method is a method that rotate the print head so that the angle of the nozzle becomes orthogonal or close to orthogonal to the printing direction. By applying a similar to machine tools such as milling machines, by using an x-axis (rotating) stepping motor 901 in addition to three stepping motors for linear motions, it enables rotating the print head 903 about the x-axis, and it enables rotating the print head 903 about the y-axis by using a y-axis (rotating) stepping motor 903.

The reason why rotating the head is that, otherwise, the nozzle may collide previously extruded filament and may have to stop printing. In such a case, if the cause of collision lies in the x-axis, the head is rotated about the y-axis, and if the cause lies in the y-axis, the head is rotated about the x-axis. In addition, if the cause concerns both the x-axis and the y-axis, the head is rotated about both the x-axis and the y-axis. This method enables printing while moving along a steep angle.

What are claimed are:

1. A method of 3D printing that inputs an extended 3D object model, in which a natural direction is specified for each of multiple internal points, and that forms a 3D printed object by arraying filaments; wherein the method comprising the steps of
(a) an extended slicing process that partitions said extended 3D object model into string-shaped portions along said natural directions and that outputs an NC program for a 3D printer, which specifies motions of the print head of said 3D printer along said string-shaped portions,
(b) an extended 3D printing process that inputs said NC program, moves said print head along each of said string-shaped portions, and fills the space specified by each of said string-shaped portions by filament to form said 3D printed object.

2. A method of 3D printing according to claim 1; wherein the method further comprising the step of
(c) an extended solid modeling process that generates a second extended 3D object model before step (a) by accumulating the motion trajectory and the motion direction of a 3D pointing device that inputs one or more locations in the physical 3D space for each time step, and the step (a) partitions said second extended 3D object model instead of said (first) extended 3D object model.

3. A method of 3D printing according to claim 2; wherein the step (c) further comprises:
by detecting the width or the shape of said motion trajectories and records said width or said shape as well as said motion trajectories and said motion directions, generating said second extended 3D object model from fewer or more number of trajectories according to said width or said shape.

4. A method of 3D printing according to claim 1; wherein the step (c) further comprises:
generating said second extended 3D object model by combining 3D model parts, each of which specifies a direction for each of multiple points inside said 3D model part.

5. A method of 3D printing according to claim 1; wherein the step (c) further comprises:
when the cross section of said string-shaped portion increases along the direction of the print-head motion, partitioning each of said string-shaped portion to multiple second string-shaped portions so that whole cross section of each second string-shaped portion can be filled with filament at once.

6. A method of 3D printing according to claim 1; wherein the step (c) further comprises:
when the cross section of said string-shaped portion decreases along the motion direction of said print head, merging two or more of said string-shaped portions into a single second string-shaped portion so that whole cross section of said second string-shaped portion can be filled with filament at once.

7. A method of 3D printing according to claim 1; wherein the step (c) further comprises:
when one of the width or the height of each of said string-shaped portions increases but the other decreases along the motion direction of said print-head, twisting horizontally-laid two string-shaped portions at front end to form vertically-layered two second string-shaped portions at back end so that whole cross section of said second string-shaped portions, which changes said width or said shape, can be filled with filament without stopping extrusion.

8. A method of 3D printing according to claim 1; wherein said print head comprises:
a thin, i.e., needle-shaped, nozzle, which is used when said natural direction is close to the vertical direction (i.e., steeply upward or downward), so that each of said string-shaped portions can be filled with filament without a collision with previously printed filament.

9. A method of 3D printing according to claim 8; wherein said print head further comprises:
insulator that covers said thin nozzle, which is used when controlling the temperature of the filament by using a thermistor over said thin nozzle, so that the difference of the temperatures of the tip of said nozzle and said thermistor is reduced.

10. A method of 3D printing according to claim 1; wherein the 3D printer comprises:
a mechanism for rotating the print head about the horizontal axis, which is used when the printing direction is close to the vertical direction (i.e., steeply upward or downward), so that said print head can be rotated and said nozzle can fill the string-shaped space by filament without a collision with to previously printed filament.

11. A method of 3D printing according to claim 1; wherein step (c) further comprises:
partitioning said second extended 3D object model into multiple portions and selecting the order of printing said multiple portions, so that said multiple portions can be printed without crashing a collision with previously printed portions.

12. A 3D printer that inputs an extended 3D object model, in which a natural direction is specified for each of multiple internal points, and that forms a 3D printed object by arraying filaments; wherein said 3D printer fills the space that corresponds to said extended 3D object model by moving a print head, which extrudes filament, along said natural direction and shapes said 3D printed object.

13. A 3D printer according to claim 12; wherein said 3D printer comprises:
a nozzle with thin, i.e., needle-like, shape, that can fill the space that corresponds to said extended 3D object model without crashing said thin nozzle to previously extruded filament even when said natural direction is close to the vertical direction (i.e., steeply upward or downward).

14. A 3D printer according to claim 13; wherein the nozzle is covered by insulator that decreases the temperature difference between the extruded filament and the thermistor, which is used for controlling the temperature of the extruded filament, and that enables exact temperature control.

15. A 3D printer according to claim 13; wherein said 3D printer comprises:
a thermistor that is used for controlling the temperature of the extruded filament and that is placed close to the tip of said nozzle so that the temperature difference between said extruded filament and said thermistor is decreased and exact temperature control is enabled.

16. A 3D printer according to claim 12; wherein said 3D printer comprises:
a mechanism for rotating said nozzle, which can fill the space by filament without a collision with extruded filament while moving along said natural direction even when said natural direction is close to the vertical direction (i.e., steeply upward or downward).
